(19) United States
(12) Patent Application Publication
(10) Pub. No.: US 2006/0134515 A1
(43) Pub. Date: Jun. 22, 2006

(54) Energy device and various applications using the same

(76) Inventors: Yoshiaki Kumashiro, Mito (JP); Juichi Arai, Shirosato (JP); Mituru Kobayashi, Hitachiota (JP); Masanori Yoshikawa, Hitachinaka (JP); Takahiro Yamaki, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/300,275

(22) Filed: Dec. 15, 2005

(30) Foreign Application Priority Data
Dec. 17, 2004 (JP) 2004-365553

(51) Int. Cl. H01M 4/02; H01M 4/52; H01M 4/50; H01M 4/58; H01G 9/155

(52) U.S. Cl. 429/209; 429/231.95; 429/223; 429/224; 429/231.3; 429/221; 361/502

(57) ABSTRACT

An object of the present invention is to provide an energy device excellent in input/output characteristics at a low temperature and various applications using the same. The present invention consists in an energy device comprising a positive electrode having a region where a faradic reaction occurs, and a negative electrode having a region where a faradic reaction occurs, wherein at least one of the positive and negative electrodes has a region where a faradic reaction having a reaction rate higher than that of the faradic reaction occurs or a region where a non-faradic reaction occurs.

### FIELD OF THE INVENTION

The present invention relates to a novel energy device storing and releasing electrical energy and various applications using the same.

### BACKGROUND ART

In these years, power supplies having higher input/output power than hitherto available are required as power supplies for electric vehicles, hybrid vehicles, electric tools or the like, and additionally, power supplies capable of rapidly charging/discharging and having high capacity are required. Particularly, power supplies having small temperature dependence and capable of maintaining input/output characteristics in a manner better than ever, even at low temperatures such as −20° C. or −30° C. are required.

Such requirements as described above have hitherto been dealt with by making higher the performance of secondary batteries being mainly faradic in reaction mechanism such as lithium secondary batteries, nickel-hydrogen batteries, nickel-cadmium batteries and lead batteries, and by using in combination electric double layer capacitors being non-faradic in reaction mechanism and satisfactory, as instantaneous input/output power supplies, in input/output characteristics and in characteristics in low temperature environments.

Also, Patent Document 1 discloses a lithium secondary battery in which an activated carbon to be used as a material for an electric double layer capacitor is mixed in the positive electrode of the lithium secondary battery for the purpose of attaining high energy density, high output density and improvement of low temperature characteristics.

Patent Document 1: JP Patent Publication (Kokai) No. 2002-260634

Conventional lithium secondary batteries disclosed in Patent Document 1 are poor in charge/discharge characteristics for large current, and have a problem that the input/output characteristics are markedly degraded particularly under low-temperature conditions and the electric double layer capacitors involved are low in energy density.

It is an object of the present invention to provide an energy device excellent in input/output characteristics at a low temperature and various applications using the same.

### SUMMARY OF THE INVENTION

The present invention consists in an energy device comprising:

a positive electrode having a region where a faradic reaction occurs; and

a negative electrode having a region where a faradic reaction occurs,
wherein at least one of the positive and negative electrodes has a region where a faradic reaction having a reaction rate higher than that of the faradic reaction occurs or a region where a non-faradic reaction occurs.

It is preferable that in the positive electrode, the region where a faradic reaction occurs has an active material that stores electricity, and the region where a faradic reaction having a higher reaction rate occurs or the region where a non-faradic reaction occurs has an active material capable of adsorbing and desorbing the active material that stores electricity, and that the region where a faradic reaction having a higher reaction rate occurs or the region where a non-faradic reaction occurs occupies 30 to 100% of an area of a portion exposed on the opposite electrode side.

It is preferable that the region where a faradic reaction occurs is formed on a current collector in a laminated manner, and the region where a faradic reaction having a higher reaction rate occurs or region where a non-faradic reaction occurs is formed on the surface of the region where a faradic reaction occurs in a laminated manner, or that the region where a faradic reaction occurs, and the region where a faradic reaction having a higher reaction rate occurs or the region where a non-faradic reaction occurs are formed in a mixed manner or alternately on the surface of the current collector. These regions are formed by a fine powder made of a material forming a reaction, and they are formed as a region having a specific size or aggregate of the powder.

It is preferable that the energy device has a separator electrically separating the positive and negative electrodes from each other and allowing a mobile ion to pass therethrough, and an electrolytic solution having a nonaqueous solvent comprising the mobile ion, that the positive and negative electrodes are provided with the region of the positive electrode where a faradic reaction occurs and the region of the negative electrode where a faradic reaction having a higher reaction rate occurs or the region where a non-faradic reaction occurs with the former and latter regions adjacent to each other via the separator, or provided with the region of the positive electrode where a faradic reaction having a higher reaction rate occurs or the region where a non-faradic reaction occurs and the region of the negative electrode where a faradic reaction occurs, the region where a faradic reaction having a higher reaction rate occurs or the region where a non-faradic reaction occurs with the former and latter regions adjacent to each other via the separator, and that the mobile ion has a Li salt or Li compound.

It is preferable that in the positive electrode, the region where a faradic reaction occurs has an active material having a lithium ion, and the region where a faradic reaction having a higher reaction rate or the region where a non-faradic reaction occurs has an active material capable of adsorbing and desorbing the lithium ion, that the active material having a lithium ion comprises at least one of LiNiₓMn_{y}Co_{z}O₂(x+y+z=1), a composite oxide composed of Li and at least one of transition metals Co, Ni and Mn, and a compound having an olivine structure represented LiMePO₄ (wherein Me is Fe, Co, Cr), and that the composite oxide is composed of at least one of LiCoO₂, LiNiO₂, LiMn₂O₄ and LiNiₓMn_{y}Co_{z}O₂(x+y+z=1).

It is preferable that the region having a non-faradic reaction has a material that stores electricity, and that the material that stores electricity comprises at least one of activated carbon materials and quaternary onium cationic salts represented the formula (1).

It is preferable that an electrolytic solution or a gel electrolyte composed of a polymer and an electrolytic solution is provided between the positive electrode and negative electrode.

The above-described energy device is used in a coin-shaped on cylindrical secondary battery, a redox capacitor, and an energy device module comprising a plurality of energy devices connected in series, in parallel or in series-parallel, and in an energy device module having a control circuit that controls at least one of a current and a voltage of an electrical circuit formed by the connection. The energy device module is used an electric motor driven by power supplied from the module or an electric vehicle comprising an electric motor and an internal combustion engine.

According to the present invention, an energy device excellent in input/output characteristics at a lower temperature and various applications using the same can be provided.

### BRIEF DESCRIPTION OF THE DRAWINGS

FIG. 1 is a sectional view of a coin-shaped energy device according to the present invention;

FIG. 2 is a sectional view of the coin-shaped energy device according to the present invention;

FIG. 3 is a sectional view of the coin-shaped energy device according to the present invention;

FIG. 4 is a sectional view of a coin-shaped lithium secondary battery according to the present invention;

FIG. 5 is a sectional view of a coin-shaped lithium secondary battery according to the Comparative Example;

FIG. 6 is a line diagram showing an I-V characteristic which is used at the time of calculating an output characteristic;

FIG. 7 is a line diagram showing a discharge curve measured at −30° C.;

FIG. 8 is a sectional view of the coin-shaped energy device according to the present invention;

FIGS. 9(A) and 9(B) are line diagrams showing a relation between a cell voltage and a discharge time in pulse charge and discharge;

FIG. 10 is a perspective view of an energy device module according to the present invention; and

FIG. 11 is an underside plan view of a hybrid vehicle using the energy device module according to the present invention.

11 . . . positive electrode
12 . . . positive electrode faradic layer
13 . . . positive electrode current collector
14 . . . high-speed positive electrode faradic layer or positive electrode non-faradic layer
15 . . . negative electrode
16 . . . negative electrode faradic layer
17 . . . negative electrode current collector
18 . . . high-speed negative electrode faradic layer or negative electrode non-faradic layer
19 . . . insulating layer
1a . . . electrolytic solution
1b . . . positive electrode can
1c . . . negative electrode can
1d . . . gasket
41 . . . positive electrode
43 . . . positive electrode current collector
45 . . . negative electrode
46 . . . negative electrode active material
47 . . . negative electrode current collector
49 . . . insulating layer
4a . . . electrolytic solution
4b . . . positive electrode can
4c . . . negative electrode can
4d . . . gasket
91 . . . energy storage device
92 . . . resin container
93 . . . copper plate
94 . . . positive electrode terminal
95 . . . negative electrode terminal
96 . . . cable
97 . . . control circuit
98 . . . vent hole
101 . . . energy storage device module
102 . . . module control circuit
103 . . . driving electric motor
104 . . . engine
105 . . . inverter
106 . . . motive power control circuit
107 . . . driving shaft
108 . . . differential gear
109 . . . driving wheel
10a . . . clutch
10b . . . gear
10c . . . speed monitor

### DETAILED DESCRIPTION OF THE PREFERRED EMBODIMENTS

An energy device according to the present invention will be described below more in detail and specifically, but the present invention is not limited to the details and examples described below.

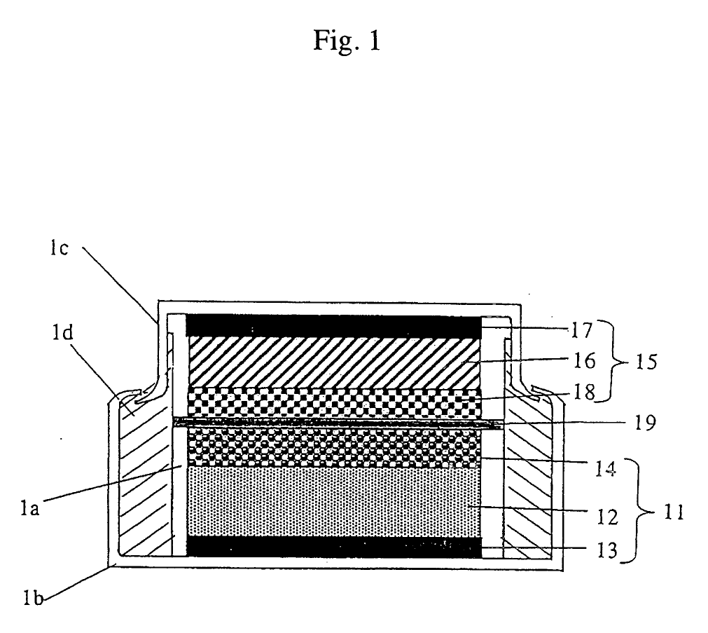

FIG. 1 is a sectional view of a coin-shaped energy device according to the present invention. A positive electrode 11 is fabricated by coating a positive electrode current collector 13 with a positive electrode faradic layer 12 having a region where a faradic reaction occurs, and a layer having a region where a faradic reaction having a reaction rate higher than that of the positive electrode faradic layer 12 (hereinafter referred to as high-speed positive electrode faradic layer) or a layer having a region where a non-faradic reaction occurs (hereinafter referred to as positive electrode non-faradic layer) 14.

A negative electrode 15 is fabricated by coating a negative electrode current collector 17 with a negative electrode faradic layer 16 having a region where a faradic reaction occurs, and a layer having a region wp where a faradic reaction having a reaction rate higher that that of the negative electrode faradic layer 16 (hereinafter referred to as high-speed negative electrode faradic layer) or a layer having a region where a non-faradic reaction occurs (hereinafter referred to as negative electrode non-faradic layer) 18.

In the present invention, the “layer having a region where a faradic reaction occurs” means a layer having a reaction in which the oxidized state of an active material changes, and a charge passes through an electrical double layer, and transfers into the active material through an electrode interface, and a region where the reaction occurs. This is a mechanism similar to that of a reaction in a primary battery or secondary battery. The “layer having a region where a faradic reaction having a higher reaction rate or a layer having a region where a non-faradic reaction occurs” means a layer having a reaction in which transfer of a charge through an electrode interface does not occur, and an ion is physically adsorbed to an electrode surface and desorbed therefrom to charge and discharge, and a region where the reaction occurs. This is a mechanism similar to that of a reaction in an electrical double layer capacitor.

The non-faradic reaction is a reaction involving a faradic reaction in which charges are accumulated on an electrode surface and at the same time, an exchange of electrodes with an active material occurs. This is a mechanism similar to that of a reaction in an energy device called a redox capacitor, and involves a faradic reaction, but its reaction rate is higher than that of a faradic reaction in a secondary battery or the like. In this regard, faradic reactions in the redox capacitor and the secondary battery are referred to as faradic reactions having different reaction rates, and the faradic reaction in the redox capacitor is referred to as a faradic reaction having a higher reaction rate, and the faradic reaction in the secondary battery is referred to as a faradic reaction having a low reaction rate.

Terms of “faradic” and “non-faradic” are used for grouping as the type of battery and the energy storage form. The layer having a region where a faradic reaction having a higher reaction rate occurs or the layer having a region where a non-faradic reaction occurs can be localized on the side closer to the opposite electrode, thus making it possible to more strongly exhibit an effect similar to that of the capacitor. The area of a portion in which the layer having a region where a non-faradic reaction occurs is exposed on the electrode side is preferably 30 to 100%.

If activated carbon for use as a material of the electrical double layer capacitor is mixed in a positive electrode of a lithium secondary battery within the conventional lithium secondary battery, it is difficult to increase the amount of activated carbon blended and the capacity of the capacitor is low, and therefore a sufficient improvement is not found.

According to the energy device of this embodiment, an energy device having a better output characteristic particularly at a low temperature can be obtained. This energy device is produced by electrically insulating the positive electrode 11 and the negative electrode 15 from each other, sandwiching an insulating layer 19 allowing only a mobile ion to pass therethrough between the electrodes, inserting them into a case, and then injecting an electrolytic solution 1a. A positive electrode can 1b and a negative electrode can 1c are sealed by a gasket 1d and insulated from each other. By sufficiently retaining the electrolytic solution 1a in the insulating layer 19 and each electrode, electrical insulation between the positive electrode 11 and the negative electrode 15 is ensured, and it is made possible to exchange ions between the positive electrode and the negative electrode.

In the energy device in this embodiment, the positive electrode faradic layer 12, the positive electrode faradic layer having a reaction rate higher than that of the positive electrode faradic layer 12 or the positive electrode non-faradic layer 14, the insulating layer 19, the negative electrode faradic layer having a reaction rate higher than that of the negative electrode faradic layer 16 or the negative electrode non-faradic layer 18, and the negative electrode faradic layer 16 are stacked in this order as described previously.

In the case of a cylindrical-shaped energy device as a shape other than the coin shape, a positive electrode having stacked a positive electrode current collector, a positive electrode, and a layer in which a faradic reaction having a higher reaction rate or a non-faradic reaction occurs, and a negative electrode having stacked a negative electrode current collector, a negative electrode, and a layer in which a faradic reaction having a higher reaction rate or a non-faradic reaction occurs are situated such that the layers in which a faradic reaction having a higher reaction rate or a non-faradic reaction occurs face each other, and the electrodes are wound with an insulating layer inserted therebetween to produce an electrode assembly. If the electrodes are biaxially wound, an oblong-shaped electrode assembly is obtained. In the case of a rectangular shape, the positive electrode and the negative electrode are cut into strips, the positive electrode and the negative electrode are stacked alternately, and an insulating layer is inserted between the electrodes to fabricate an electrode assembly. The structure of the above-mentioned electrode assembly may be any of the coin shape, the winding type and the rectangular shape and is a matter of choice.

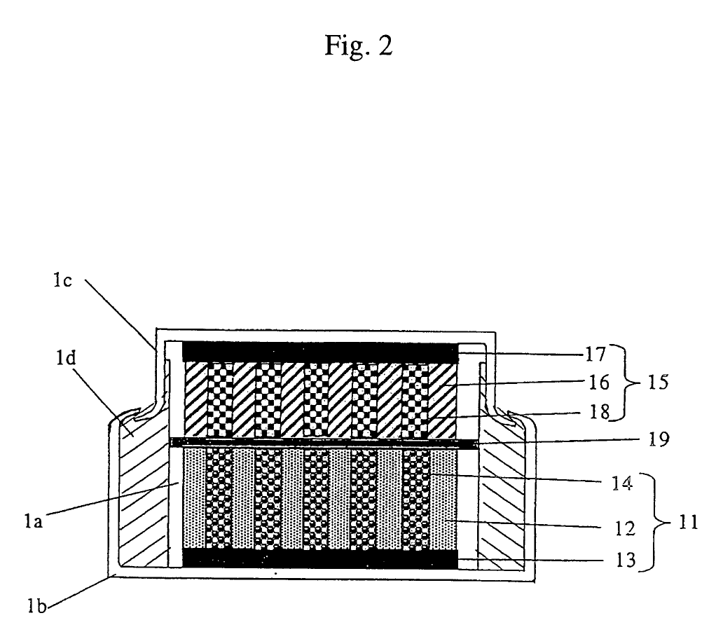

FIG. 2 is a sectional view of a coin-shaped energy device showing another example according to the present invention. In FIG. 2, the positive electrode 11 and the negative electrode 15 are aligned along a longitudinal direction of the coin-shaped battery with the insulating layer 19 held therebetween. The positive electrode faradic layer 12 and the high-speed positive electrode faradic layer or positive electrode non-faradic layer 14 in FIG. 2 are arranged along a lateral direction and stacked along a direction in which the positive electrode current collector extends. The same holds true for the relation between the negative electrode faradic layer 16 and the high-speed negative electrode faradic layer or negative electrode non-faradic layer 18.

A method for fabricating the positive electrode 11 and the negative electrode 15 using the positive electrode faradic layer 12 and the negative electrode faradic layer 16 capable of inserting and desorbing a lithium ion as an active material undergoing a faradic reaction will be described below.

(1) The positive electrode active material of the positive electrode faradic layer 12 is composed of an oxide containing lithium. For this material, for example, oxides having a layered structure, such as LiCoO2, LiNiO₂, LiMn_{1/3}Ni_{1/3}Co_{1/3}O₂ and LiMn_{0.4}Ni_{0.4}CO_{0.2}O₂, oxides of Mn having a spinel-type structure, such as LiMn₂O₄ and Li₁₊ₓMn₂₋ₓO₄, and compounds with part of Mn substituted by other elements such as Co and Cr may be used.

Since the positive electrode active material generally has a high resistance, the electric conductivity of the positive electrode active material is complemented by mixing a carbon powder as a conductive agent. Since the positive electrode active material and the conductive agent are both powders, they are mixed with a binder, and the resultant mixture is coated and shaped on the positive electrode current collector 13. The positive electrode current collector 13 should be a material hard to be dissolved in an electrolytic solution, and for example, an aluminum foil may be used. For the conductive agent, natural graphite, artificial graphite, coke, carbon black, amorphous carbon and the like may be used.

The positive electrode faradic layer 12 is fabricated by a doctor blade method in which a positive electrode slurry obtained by mixing the positive active material, the conductive agent, the binder and an organic solvent together is applied to the positive electrode current collector 13 using a blade, and the organic solvent is dried away by heating.

In the energy device of this embodiment, a layer where a faradic reaction having a higher reaction rate or a non-faradic reaction occurs is further applied to the positive electrode faradic layer 12 thus fabricated.

For the layer where a non-faradic reaction occurs, materials having a large specific surface area and undergoing no oxidization-reduction reaction over a wide range of potentials, for example carbon materials such as activated carbon, carbon black, carbon nanofibers and carbon nanotubes may be used. For example, it is desirable to use activated carbon in terms of the specific surface area and the cost of the material. More preferably, activated carbon having a particles size of 1 to 100 μm, a specific surface area of 1000 to 3000 m²/g, and having pores called micropores having a diameter of 0.002 μm or less, pores called mesopores having a diameter of 0.002 to 0.05 μm, and pores called macropores having a diameter of 0.05 μm or greater is used.

For the region where a faradic reaction having a higher reaction rate occurs, materials such as conductive polymer materials including polyaniline, polythiophene, polypyrrole, polyacene, polyacetylene and the like, and graphite fine powders may be used.

A slurry obtained by mixing these materials with a binder is applied to the positive faradic layer 12, and a high-speed positive electrode faradic layer or positive electrode non-faradic layer is bonded to the positive electrode faradic layer 12. The positive electrode can be fabricated by heating the positive electrode assembly thus fabricated and the high-speed positive electrode faradic layer or positive electrode non-faradic layer to dry away an organic solvent, pressure-forming the positive electrode by a roll press, and bringing the positive electrode current collector 13, the positive electrode faradic layer 12 and the high-speed positive electrode faradic layer or positive electrode non-faradic layer 14 into close contact with one another.

The binder which is used here is a fluororesin such as polytetrafluoroethylene, polyvinylidene fluoride or fluororubber, a thermoplastic resin such as polypropylene or polyethylene, a thermosetting resin such as polyvinyl alcohol, or the like.

(2) The negative electrode active material can use graphite or amorphous carbon capable of electrochemically occluding and releasing lithium. Beside the carbon material, an oxide such as SnO₂, or an alloy material containing Li, Si, Sn and the like may be used. A composite material of an oxide or alloy material and a carbon material can be used. Since the negative electrode active material is generally a powder, it is mixed with a binder, and the resultant mixture is coated and shaped on the negative electrode current collector 17. The negative electrode current collector 17 should be a material hard to form an alloy with lithium, and for example, a copper foil may be used. A negative electrode slurry obtained by mixing a negative electrode active material, a binder and an organic solvent is deposited on the negative electrode current collector 17 by the doctor blade method or the like, and then the organic solvent is dried to form the negative electrode faradic layer 16. A high-speed negative electrode faradic layer or negative electrode non-faradic layer can also be coated or alternately formed on the negative electrode faradic layer 16 as in the case of the positive electrode.

For the region where a non-faradic reaction occurs, materials having a large specific surface area and undergoing no oxidization-reduction reaction over a wide range of potentials, for example carbon materials such as activated carbon, carbon black, and carbon nanotubes, or materials capable of occluding and releasing a lithium ion, such as a graphite fine powder may be used.

For the region where a faradic reaction having a higher reaction rate occurs, materials such as conductive polymer materials including polyaniline, polythiophene, polypyrrole, polyacene, polyacetylene and the like, and graphite fine powders may be used. A slurry obtained by mixing these materials with a binder is applied to the negative electrode current collector 17, and a high-speed negative electrode faradic layer or negative electrode non-faradic layer is bonded to the negative electrode current collector 17.

The negative electrode 15 can be fabricated by pressure-forming the negative electrode this coated by a roll press.

(3) The insulating layer 19 is composed of a porous film of a polymer such as polyethylene, polypropylene or ethylene tetrafluoride serving as an insulating film electrically insulating the positive electrode 11 and the negative electrode 15 and allowing only mobile ions.

(4) For the electrolytic solution 1a, a solution having a lithium salt electrolyte such as lithium phosphate hexafluoride (LiPF₆) or lithium borate tetrafluoride (LiBF₄) contained in an organic solvent such as ethylene carbonate (EC), propylene carbonate (PC), dimethyl carbonate (DMC), diethyl carbonate (DEC) or methyl ethyl carbonate (MEC) in an amount of 0.5 to 2 M in terms of a volume concentration may be used.

For a preferable electrolyte, a solvent having mixed therein at least one solvent selected from propylene carbonate, butylenes carbonate, dimethyl carbonate, ethyl methyl carbonate, diethyl carbonate, methyl acetate, ethyl acetate, propyl acetate, methyl formate, ethyl formate, propyl formate, γ-butyrolactone, α-acetyl-γ-butyrolactone, α-methoxy-γ-butyrolactone, dioxolane, sulfolane and ethylene sulfite. A solution having a lithium salt electrolyte such as LiPF₆, LiBF₄, ₂LiSOCF₃, LiN[SO₂CF₃]₂, LiN[SO₂CF₂CF₃]₂, LiB[OCOCF₃]₄ or LiB[OCOCF₂CF₃]₄ contained in the above-mentioned solvent in an amount of 0.5 to 2 M in terms of a volume concentration may be used.

In addition to the Li salt or Li compound, a salt including a quaternary onium cation, such as tetraalkyl phosphonium tetrafluoroborate, tetraalkyl ammonium tetrafluoroborate or triethylemethyl ammonium tetrafluoroborate represented the formula (1) may be added.
[Formula (1)]

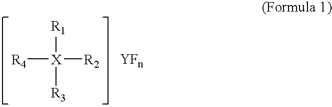

In the formula, R1, R2, R3 and R4 each represent H or a C₁₋₃ alkyl group, and they may be same or different; X is N or P; Y is B, P or As; and n is an integer of 4 or 6.

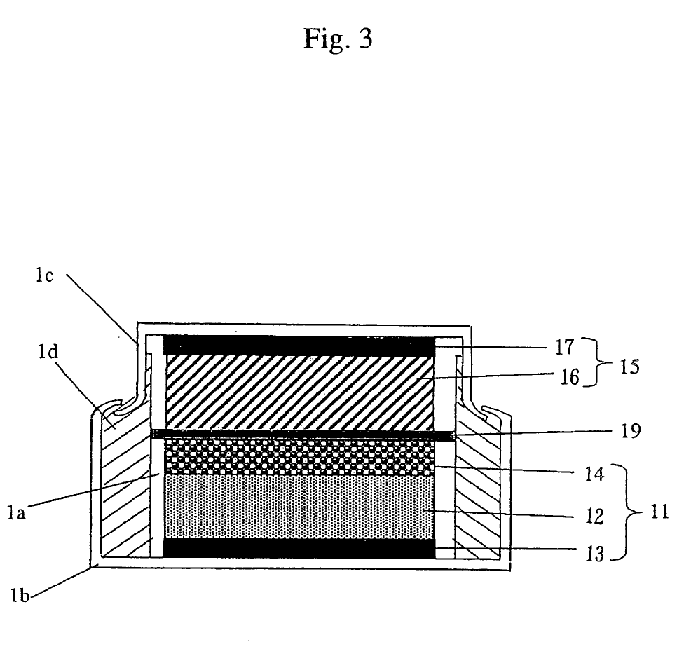

In the above description, the positive electrode 11 and the negative electrode 15 are both provided with a layer where a high-speed faradic reaction or non-faradic reaction occurs based on FIGS. 1 and 2, but a high-speed positive electrode faradic layer or positive electrode non-faradic layer 14 may be formed only on the positive electrode 11 as shown in FIG. 3. For the form of the positive electrode or negative electrode, the longitudinal direction/longitudinal direction, lateral direction/lateral direction, longitudinal direction/lateral direction or lateral direction/longitudinal direction may be appropriately selected and used.

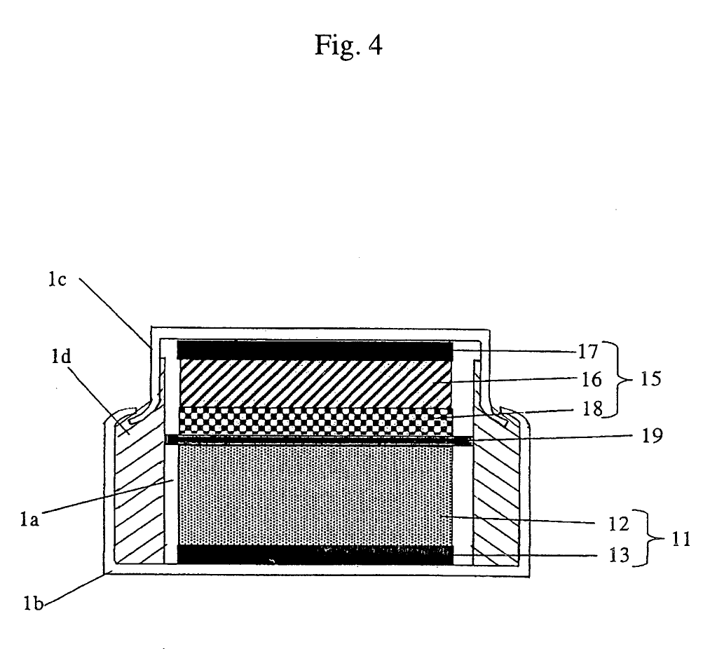

As shown in FIG. 4, an energy device can also be fabricated by forming a high-speed negative electrode faradic layer or negative electrode non-faradic layer 18 only on the negative electrode 15, and replacing the insulating layer 19 of FIGS. 1 to 4 by a gel electrolyte.

The gel electrolyte can be fabricated by swelling a polymer such as polyethylene oxide (PEO), polymethacrylate (PMMA), polyacrylonitrile (PAN), polyvinylidene fluoride (PVdF) or a polyvinylidene fluoride-hexafluoropropylene copolymer (PVdF-HFP) with an electrolytic solution.

For obtaining an energy device module using the energy device described above, a plurality of energy devices are connected in series according to voltages to be obtained. Voltage detecting means for detecting these individual voltages, and means for controlling charge and discharge currents passing through the energy devices are installed, and means for giving directives to the voltage detecting means and the current controlling means is provided. Communication is performed between the means with electrical signals.

When the voltage of each energy device detected by the means for detecting a voltage is lower than a preset charge voltage, a current is made to pass through the energy device to charge the energy device during charging. The energy device of which the voltage has reached the set charge voltage prevents the energy device from being overcharged by prohibiting passage of a charge current by an electrical signal from the means for giving directives.

At the time of charging, when the voltages of the individual energy devices, detected by the voltage detecting units are lower than the preset charging voltages, electric currents are made to flow into the energy devices to charge the devices. For the energy devices having reached the preset charging voltages, the electric signals from the units for sending commands make the charging currents not flow into the energy devices so as to prevent the overcharge thereof.

On the other hand, at the time of discharging, similarly the voltages of the individual energy devices are detected by the units for detecting voltage, and when the energy devices reach the predetermined discharging voltages, the discharging currents are made not to flow. As for the precision of the voltage detection, the voltage resolution is preferably 0.1 V or less, and more preferably 0.02 V or less. The energy device module can be actualized by detecting the voltages of the individual energy devices in satisfactory precisions as described above, and by controlling the energy devices so as to be operated without undergoing overcharging or overdischarging.

### EXAMPLE 1

The coin-shaped energy device shown in FIG. 3 was fabricated. The positive electrode faradic layer 12 was fabricated in the following manner. The positive electrode active material was Li_{1.05}Mn_{1.95}O₄ having an average particle size of 10 μm, and a conducting aid obtained by mixing graphite carbon having an average particle size of 3 μm and a specific surface area of 13 m²/g and carbon black having an average particle size of 0.04 μm and a specific surface area of 40 m²/g so as to have a weight ratio of 4:1 was used. Using as a binder a solution obtained by dissolving 8 wt % of polyvinylidene fluoride in N-methylpyrolidone in advance, the positive electrode active material, the conducting aid and polyvinylidene fluoride were mixed so as to have a weight ratio of 85:10:5 and sufficiently kneaded to form a positive electrode slurry. This positive electrode slurry was applied to a one surface of the positive current collector 13 composed of an aluminum foil having a thickness of 20 micrometers, and dried. This was pressed by a roll press to fabricate an electrode.

Additionally, another slurry was prepared as follows: a 8:1 by weight carbon mixture of an activated carbon having a specific surface area of 2000 m²/g and a carbon black having an average particle size of 0.04 μm and a specific surface area of 40 m²/g was prepared; as a binder, a 8 wt % solution of polyvinylidene fluoride beforehand dissolved in N-methylpyrrolidone was used; the carbon mixture and the binder solution were mixed together so as for the ratio between the activated carbon, the carbon black and polyvinylidene fluoride to be 80:10:10; and the mixture was fully kneaded to yield the slurry. This slurry was applied to the positive electrode faradic layer 12 to form the positive electrode non-faradic layer 14. This was dried and pressed by a roll press to fabricate an electrode. This electrode was stamped out into a disk having a diameter of 16 mm to form the positive electrode 11. At this time, the weight ratio of the positive electrode active material, the conducting aid, polyvinylidene fluoride (activated carbon/positive electrode active material: 19 wt %) and activated carbon were 68:10:6:16 and the weight of activated carbon was 16 wt % based on the total weight of the positive electrode faradic layer 12 and the positive electrode non-faradic layer 14.

For the negative electrode active material, amorphous carbon having an average particle size of 10 μm and carbon black having an average particle size of 0.04 μm and a specific surface area of 40 m²/g were mechanically mixed in a weight ratio of 95:5. Using as a binder a solution obtained by dissolving 8 wt % of polyvinylidene fluoride in N-methylpyrolidone in advance, the carbon material composed of amorphous carbon and carbon black mixed previously and polyvinylidene fluoride were sufficiently kneaded so as to have a weight ratio of 90:10. This slurry was applied to one surface of the negative electrode current collector 17 composed of a copper foil having a thickness of 10 μm, and dried to form the negative electrode faradic layer 16. This was pressed by a roll press to fabricate an electrode. This electrode was stamped out into a disk having a diameter of 16 mm to form the negative electrode 15.

The insulating layer 19 composed of a polyethylene porous separator having a thickness of 40 μm was held between the positive and negative electrodes, and a mixed electrolytic solution of ethylene carbonate and ethyl methyl carbonate (volume ratio: 1/9) of 1.5 mol/dm³ LiPF₆ was injected between the positive and negative electrodes. The positive electrode can 1b and the negative electrode can 1c are sealed by the gasket 1d and mutually insulated.

### EXAMPLE 2

An energy device was fabricated in the same manner as in Example 1 except that the weight ratio of the positive electrode active material, the conducting aid, polyvinylidene fluoride and activated carbon was 74:10:6:10 based on the total weight of the positive electrode 12 and the positive electrode non-faradic layer 14, and the activated carbon contributed to a charge adsorption reaction and had a specific surface area of 2000 m²/g and a weight of 10 wt % for forming a predetermined region in the energy device of Example 1. The specific surface area of the activated carbon is preferably 2000 to 5000 m²/g.

### COMPARATIVE EXAMPLE 1

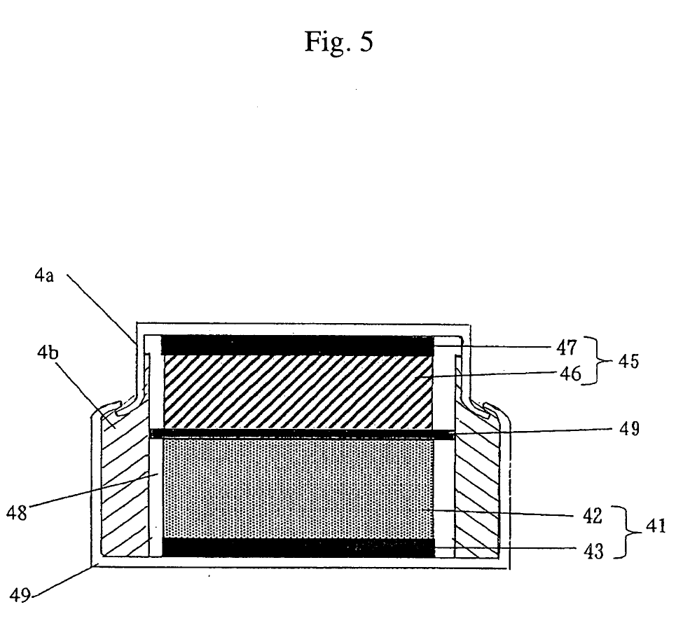

The coin-shaped lithium secondary battery shown in FIG. 5 was fabricated. A positive electrode 41 was fabricated in the following manner. A positive electrode active material 42 was Li_{1.05}Mn_{1.95}O₄ having an average particle size of 10 μm, and a conducting aid obtained by mixing graphite carbon having an average particle size of 3 μm and a specific surface area of 13 m²/g and carbon black having an average particle size of 0.04 μm and a specific surface area of 40 m²/g so as to have a weight ratio of 4:1 was used. Using as a binder a solution obtained by dissolving 8 wt % of polyvinylidene fluoride in N-methylpyrolidone in advance, the positive electrode active material, the conducting aid and polyvinylidene fluoride were mixed so as to have a weight ratio of 85:10:5 and sufficiently kneaded to form a positive electrode slurry. This positive electrode slurry was applied to a one surface of a positive current collector 43 composed of an aluminum foil having a thickness of 20 μm, and dried. This was pressed by a roll press to fabricate an electrode. This electrode was stamped out into a disk having a diameter of 16 mm to form the positive electrode 41.

A negative electrode 45 was fabricated in the following manner. As a negative electrode active material 46, amorphous carbon having an average particle size of 10 μm was mechanically mixed with carbon black having an average particle size of 0.04 μm and a specific surface area of 40 m²/g in a weight ratio of 95:5. Using as a binder a solution obtained by dissolving 8 wt % of polyvinylidene fluoride in N-methylpyrolidone in advance, the carbon material composed of amorphous carbon and carbon black mixed previously and polyvinylidene fluoride were sufficiently kneaded so as to have a weight ratio of 90:10. This slurry was applied to one surface of a negative electrode current collector 47 composed of a copper foil having a thickness of 10 μm, and dried. This was pressed by a roll press to fabricate an electrode. This electrode was stamped out into a disk having a diameter of 16 mm to form the negative electrode 45. An insulating layer 49 composed of a polyethylene porous separator having a thickness of 40 μm was held between the positive and negative electrodes, and a mixed electrolytic solution 4a of ethylene carbonate and ethyl methyl carbonate (volume ratio: 1/9) of 1.5 mol/dm³ LiPF₆ was injected between the positive and negative electrodes. A positive electrode can 4b and a negative electrode can 4c are sealed by a gasket 4d and mutually insulated.

### COMPARATIVE EXAMPLE 2

An electrode was fabricated in the same manner as in the positive electrode 41 of Comparative Example 1 except that the weight ratio of the positive electrode active material, the conducting aid, polyvinylidene fluoride and activated carbon was 68:10:6:16. Although this positive electrode includes activated carbon, activated carbon is not stacked as in the positive electrode faradic layer 12 and the positive electrode non-faradic layer 14 of Example 1, but is mixed in the positive electrode 41. A coin-shaped lithium secondary battery is fabricated in the same manner as in Comparative Example 1 except that this positive electrode is used. For this electrode, most bonding agent peeled off from an aluminum foil when the electrode was pressed by a roll press, and thus a normal electrode could not be obtained.

### COMPARATIVE EXAMPLE 3

An electrode was fabricated in the same manner as in the positive electrode 41 of Comparative Example 1 except that the weight ratio of the positive electrode active material, the conducting aid, polyvinylidene fluoride and activated carbon was 74:10:6:10. Although this positive electrode includes activated carbon, activated carbon is not stacked as in the positive electrode faradic layer 12 and the positive electrode non-faradic layer 14 of Example 1, but is mixed in the positive electrode 41. A coin-shaped lithium secondary battery is fabricated in the same manner as in Comparative Example 1 except that this positive electrode is used.

(Output Characteristic Evaluation Method)

The output characteristic at a lower temperature was evaluated using the energy devices of Examples 1 and 2 and the lithium secondary batteries of Comparative Examples 1 and 3. Charge and discharge was carried out at a temperature of 25° C. under the following conditions. First, constant current and constant voltage charging of carrying out charging at a constant current having a current density of 0.85 mA/cm² up to a voltage of 4.1 V and then carrying out charging at a constant voltage of 4.1 V was carried out for 3 hours. After the charging was completed, a pause time of 30 minutes was taken, and then discharge was carried out at a constant current of 0.28 mA/cm² up to a discharge end voltage of 2.7 V.

Same charge and discharge was repeated in 5 cycles. The discharge capacity of the fifth cycle was determined to be the discharge capacity of each energy device. Thereafter, constant current and constant voltage charging of carrying out charging at a constant current of 85 mA/cm² and then carrying out charging at a constant voltage of 4.1 V was carried out for 3 hours. The state of carrying out charging up to 4.1 V is DOD=0%. In this state, the energy device and the lithium secondary battery were put in a temperature controlled bath at −30° C. Then, after about an hour passed, discharge was carried out for a short time of 10 seconds at currents of 0.08 mA/cm², 1.7 mA/cm² and 3.4 mA/cm² to examine the output characteristic.

After a pause of 10 minutes after each discharge, the capacity discharged by each discharge is charged at 0.17 mA/cm². For example, charge after discharge at 1.7 mA/cm² for 10 seconds is carried out at 0.17 mA/cm² for 100 seconds. A pause of 30 minutes was taken after this charge, and a next measurement was made after the voltage was stabilized. Thereafter, discharge was carried out at a constant current of 0.17 mA/cm² up to a voltage of DOC=40%.

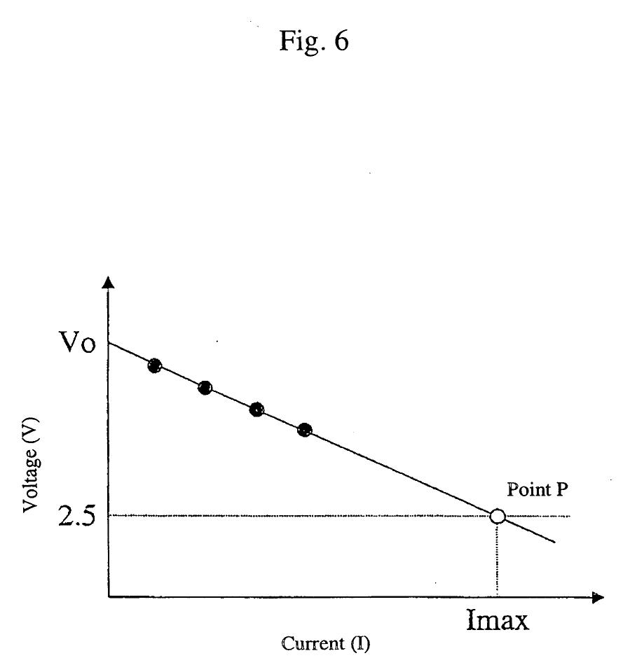

Thereafter, the output characteristic was examined under conditions same as those of DOC=0% shown previously. A voltage 2 seconds after the start of discharge was read from a charge and discharge curve obtained by this 10 second charge and discharge test, plotted with the axis of abscissa as the current value during measurement and the axis of ordinate as the voltage 2 seconds after the start of measurement, and extrapolated with a line obtained by the least square method from the I-V characteristic shown in FIG. 6, and the point P where the line intersected 2.5 V was determined. The output was calculated as (current value Imax of extrapolated intersection point P)×(start voltage Vo of each charge and discharge).

(Pulse Cycle Characteristic Evaluation Method)

The energy devices of Examples 1 and 2 and the lithium secondary batteries of Comparative Examples 1 and 3 were used to carry out charge and discharge at a temperature of 25° C. under the following conditions. First, constant current and constant voltage charging of carrying out charging at a constant current having a current density of 0.85 mA/cm² up to a voltage of 4.1 V and then carrying out charging at a constant voltage of 4.1 V was carried out for 3 hours. After the charging was completed, a pause time of 30 minutes was taken, and then discharge was carried out at a constant current of 0.28 mA/cm² up to a discharge end voltage of 2.7 V.

Same charge and discharge was repeated in 5 cycles. Thereafter, charge was carried out at a constant current having a current density of 0.85 mA/cm² up to 3.65 V. Immediately thereafter, pulse charge and discharge of carrying out discharge at a constant current having a current density of 17 mA/cm² for 10 seconds and carrying out charging at a constant current having a current density of 17 mA/cm² for 10 seconds was carried out with total 20 seconds for the 10 second discharge and 10 second charge as one cycle. Each time the pulse charge and discharge was carried out in 200 cycles, discharge was carried out at a constant current having a current density of 0.85 mA/cm² up to a voltage of 2.7 V, charge was carried out at a constant current having a current density of 0.85 mA/cm² up to a voltage of 3.65 V, and then pulse charge and discharge was carried out again 2000 times. Pulse charge and discharge was carried out 22000 times in total while discharge at a constant current having a current density of 0.85 mA/cm² up to a voltage of 2.7 V and charge at a constant current having a current density of 0.85 mA/cm² up to a voltage of 3.65 V were carried out in this way. Rates of increase of resistance of energy devices and lithium secondary batteries before the start of the pulse charge and discharge test and after 20000 cycles were compared.

The rate of increase of resistance was determined in the following manner. First, a voltage after 5 seconds in the first 10 second discharge when the first pulse charge and discharge was carried out was measured, and a voltage difference between the measured voltage and 3.65 V was determined. A value obtained by dividing this voltage difference by the discharge voltage was determined to be a first resistance R₁. In the same manner, a 20001st resistance R₂₀₀₀₁ was determined from a voltage after 5 seconds in the 20001st 10 second discharge. The rate of increase of resistance ΔR [%] after 20000 cycles was calculated as (R₂₀₀₀₁/R₁−1)×100 from the resistance R₁ and resistance R₂₀₀₀₁.

Table 1 shows the results of low-temperature characteristic evaluation. These values are relative values where the output of the energy device of Comparative Example 1 is 1. In both DOD=0% and DOD=0.40%, the characteristic of the energy device of Example 1 is superior to the characteristic of the lithium secondary battery of Comparative Example, and in DOD=40%, an output nearly as high as that in Comparative Example 1 could be obtained.

[Table 1]

TABLE 1

Output ratio

| Items | DOD = 0% | DOD = 40% |
|---|---|---|
| Example 1 | 1.14 | 1.79 |
| Comparative Example 1 | 1 | 1 |
| Comparative Example 3 | 1.07 | 1.11 |

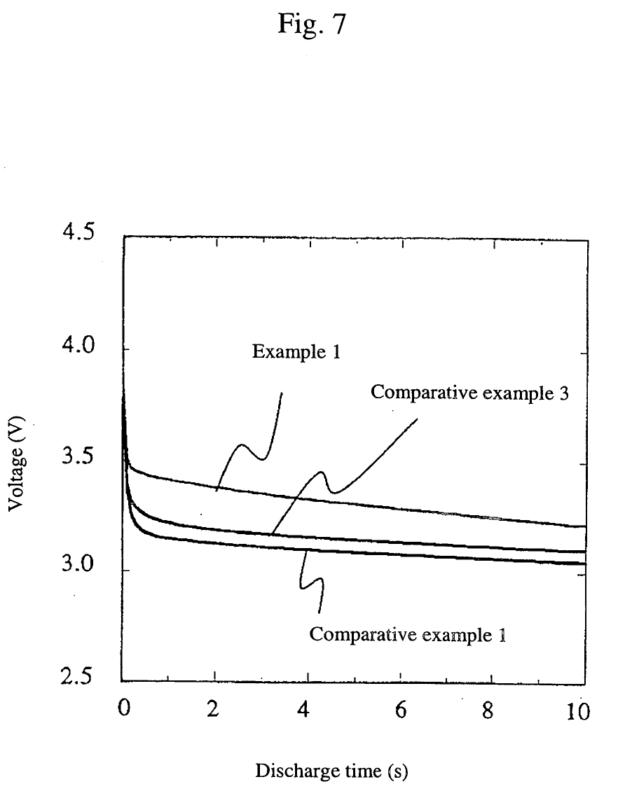

FIG. 7 is a line diagram showing a relation between a voltage and a discharge time. Discharge curves by discharging the energy device of Example 1 and the lithium secondary battery of Comparative Example 1 at −30° C. and DOD=40% and at 3.4 mA/cm² for 10 seconds. As shown in FIG. 7, it is apparent that a change in voltage after the start of discharge for the energy device of Example 1 is obviously smaller than that for the lithium secondary battery of Comparative Example 1, and the output characteristic is improved. From the above description, it is apparent that use of the energy device of this example can considerably improve the output characteristic at a low temperature.

### EXAMPLE 3

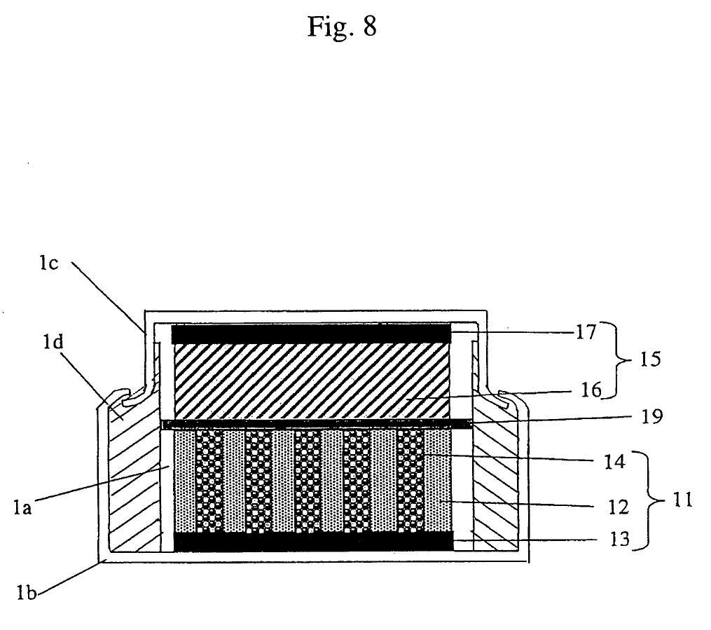

FIG. 8 is a sectional view of the coin-shaped energy device according to the present invention. The positive electrode faradic layer 12 was applied to one surface of the positive electrode current collector 13 composed of an aluminum foil having a width of 1 mm and a thickness of 20 μm using the positive electrode slurry of Comparative Example 1, provided with uncoated areas at intervals of 1 or 2 mm, and dried. Activated carbon having a specific surface area of 2000 m²/g and carbon black having an average particle size of 0.04 μm and a specific surface area of 40 m²/g were mixed so as to have a weight ratio of 8:1, and using as a binder a solution obtained by dissolving 8 wt % of polyvinylidene fluoride in N-methylpyrolidone in advance, activated carbon, carbon black and polyvinylidene fluoride were mixed so as to have a weight ratio of 80:10:10 and sufficiently kneaded to form a slurry. This slurry was applied to the uncoated areas of a positive electrode current collector 113 to form the positive electrode non-faradic layer 14. This was dried, and pressed by a roll press to fabricate an electrode. This electrode was stamped out into a disk having a diameter of 16 mm to form the positive electrode 11. At this time, the weight ratio of the positive electrode active material, the conducting aid and polyvinylidene fluoride and activated carbon based on the total weight of the positive electrode faradic layer 12 and the positive electrode non-faradic layer 14 was 68:10:6:16, and the weight of activated carbon was 16 wt %.

For the negative electrode 15, a layer was applied to the negative electrode current collector 17 and pressed to fabricate an electrode in the same manner as in the negative electrode 45 of Comparative Example 1. This electrode was stamped out into a disc having a diameter of 16 mm to form the negative electrode 15.

The insulating layer 19 composed of a polyethylene porous separator having a thickness of 40 μm was held between the positive and negative electrodes, and the mixed electrolytic solution 1a of ethylene carbonate and ethyl methyl carbonate (volume ratio: 1/9) of 1.5 mol/dm³ LiPF₆ was injected between the positive and negative electrodes. The positive electrode can 1b and the negative electrode can 1c are sealed by the gasket 1d and mutually insulated.

### EXAMPLE 4

The coin-shaped energy device shown in FIG. 8 was fabricated. The positive electrode faradic layer 12 was applied to one surface of the positive electrode current collector 13 composed of an aluminum foil having a width of 2 mm and a thickness of 20 μm using the positive electrode slurries of Comparative Example 1 and Example 3, provided with uncoated areas at intervals of 1 mm, and dried. As in Example 3, activated carbon having a specific surface area of 2000 m²/g and carbon black having an average particle size of 0.04 μm and a specific surface area of 40 m²/g were mixed so as to have a weight ratio of 8:1, and using as a binder a solution obtained by dissolving 8 wt % of polyvinylidene fluoride in N-methylpyrolidone in advance, activated carbon, carbon black and polyvinylidene fluoride were mixed so as to have a weight ratio of 80:10:10 and sufficiently kneaded to form a slurry. This slurry was applied to the uncoated areas of the positive electrode current collector 13 to form the positive electrode non-faradic layer 14. This was dried, and pressed by a roll press to fabricate an electrode. This electrode was stamped out into a disk having a diameter of 16 mm to form the positive electrode 11. At this time, the weight ratio of the positive electrode active material, the conducting aid and polyvinylidene fluoride and activated carbon based on the total weight of the positive electrode faradic layer 12 and the positive electrode non-faradic layer 14 was 68:10:6:16, and the weight of activated carbon was 16 wt %.

For the negative electrode 15, a layer was applied to the negative electrode current collector 17, and pressed to fabricate an electrode having the negative electrode faradic layer 16 in the same manner as in the negative electrode 45 of Comparative Example 1. This electrode was stamped out into a disc having a diameter of 16 mm to form the negative electrode 15. The insulating layer 19 composed of a polyethylene porous separator having a thickness of 40 μm was held between the positive and negative electrodes, and the mixed electrolytic solution 1a of ethylene carbonate and ethyl methyl carbonate (volume ratio: 1/9) of 1.5 mol/dm³ LiPF₆ was injected between the positive and negative electrodes. The positive electrode can 1b and the negative electrode can 1c are sealed by the gasket 1d and mutually insulated.

Using the energy devices of Examples 3 and 4 and the lithium secondary battery of Comparative Example 1, the output characteristic at a low temperature was evaluated by the method.

Table 2 shows the results of low-temperature characteristic evaluation. These values are relative values where the output of the energy device of Comparative Example 1 is 1. As shown in Table 2, in both DOD=0% and DOD=0.40%, the characteristic of the energy device of Example 1 is superior to the characteristic of the lithium secondary battery of Comparative Example 1, and particularly in DOD=40%, an output nearly twice as high as that in Comparative Example 1 could be obtained. From the above description, it is apparent that use of the energy device of the present invention can considerably improve the output characteristic at a low temperature.

[Table 2]

TABLE 2

Output ratio

| Items | DOD = 0% | DOD = 40% |
|---|---|---|
| Example 3 | 1.18 | 1.89 |
| Example 4 | 1.14 | 1.75 |
| Comparative Example 1 | 1 | 1 |

It is also conceivable that a layer where a high-speed faradic reaction or non-faradic reaction occurs is formed only on the positive electrode 11 based on the structure in FIG. 8. Even if a layer where a high-speed faradic reaction or non-faradic reaction occurs is formed only on the negative electrode, the energy device can be fabricated. A gel electrolyte can be used as the insulating layer 19 of FIG. 8.

### EXAMPLE 5

A coin-shaped energy device was fabricated in the same manner as in Example 1 except that LiCoO₂ having an average particle size of 9 μm was used instead of the positive electrode active material of Example 1.

### EXAMPLE 6

A coin-shaped energy device was fabricated in the same manner as in Example 1 except that LiNiO₂ having an average particle size of 7 μm was used instead of the positive electrode active material of Example 1.

### EXAMPLE 7

A coin-shaped energy device was fabricated in the same manner as in Example 1 except that LiNi_{0.8}Co_{0.2}O₂ was used instead of the positive electrode active material of Example 1.

### EXAMPLE 8

A coin-shaped energy device was fabricated in the same manner as in Example 1 except that LiNi_{0.8}Co_{0.15}Al_{0.05}O₂ having an average particle size of 10 μm was used instead of the positive electrode active material of Example 1.

### EXAMPLE 9

A coin-shaped energy device was fabricated in the same manner as in Example 1 except that LiMn_{1/3}Ni_{1/3}Co_{1/3}O₂ was used instead of the positive electrode active material of Example 1.

### COMPARATIVE EXAMPLE 4

A coin-shaped lithium secondary battery was fabricated in the same manner as in Comparative Example 1 except that LiCoO₂ was used instead of the positive electrode active material of Comparative Example 1.

### COMPARATIVE EXAMPLE 5

A coin-shaped lithium secondary battery was fabricated in the same manner as in Comparative Example 1 except that LiNiO₂ was used instead of the positive electrode active material of Comparative Example 1.

### COMPARATIVE EXAMPLE 6

A coin-shaped lithium secondary battery was fabricated in the same manner as in Comparative Example 1 except that LiNi_{0.8}Co_{0.2}O₂ was used instead of the positive electrode active material of Comparative Example 1.

### COMPARATIVE EXAMPLE 7

A coin-shaped lithium secondary battery was fabricated in the same manner as in Comparative Example 1 except that LiNi_{0.8}Co_{0.15}Al_{0.05}O₂ having an average particle size of 6 μm was used instead of the positive electrode active material of Comparative Example 1.

### COMPARATIVE EXAMPLE 8

A coin-shaped lithium secondary battery was fabricated in the same manner as in Comparative Example 1 except that LiMn_{1/3}Ni_{1/3}Co_{1/3}O₂ was used instead of the positive electrode active material of Comparative Example 1.

In a manner same as that described previously, the discharge capacity and the output characteristic and pulse cycle characteristic at −30° C. were evaluated using the energy devices of Examples 1 and 5 to 9 and Comparative Examples 1 and 4 to 8 by the methods described in “Output characteristic evaluation method” and “pulse cycle characteristic evaluation method”.

Table 3 shows the discharge capacity, the output density at −30° C. and DOD=0% and ΔR. Each of the values is a relative value where the value in Comparative Example 1 is 1. The positive electrode active material is the same for Example 1 and Comparative Example 1, Example 5 and Comparative Example 4, Example 6 and Comparative Example 5, Example 7 and Comparative Example 6, Example 8 and Comparative Example 7, and Example 9 and Comparative Example 8, and the energy device having the positive electrode non-faradic layer of this example has an increased output density at −30° C., and has low ΔR in the evaluation of the pulse cycle characteristic. Low ΔR means that a decrease in output is small, and hence that the characteristic is improved.

[Table 3]

TABLE 3

| | Output ratio | |
|---|---|---|
| Items | DOD = 0% | ΔR |
| Example 1 | 1.14 | 0.13 |
| Example 5 | 1.30 | 0.11 |
| Example 6 | 1.32 | 0.24 |
| Example 7 | 1.29 | 0.19 |
| Example 8 | 1.33 | 0.16 |
| Example 9 | 1.35 | 0.09 |
| Comparative Example 1 | 1 | 1 |
| Comparative Example 4 | 1.06 | 0.93 |
| Comparative Example 5 | 1.09 | 1.33 |
| Comparative Example 6 | 1.08 | 1.21 |
| Comparative Example 7 | 1.09 | 1.18 |
| Comparative Example 8 | 1.11 | 0.87 |

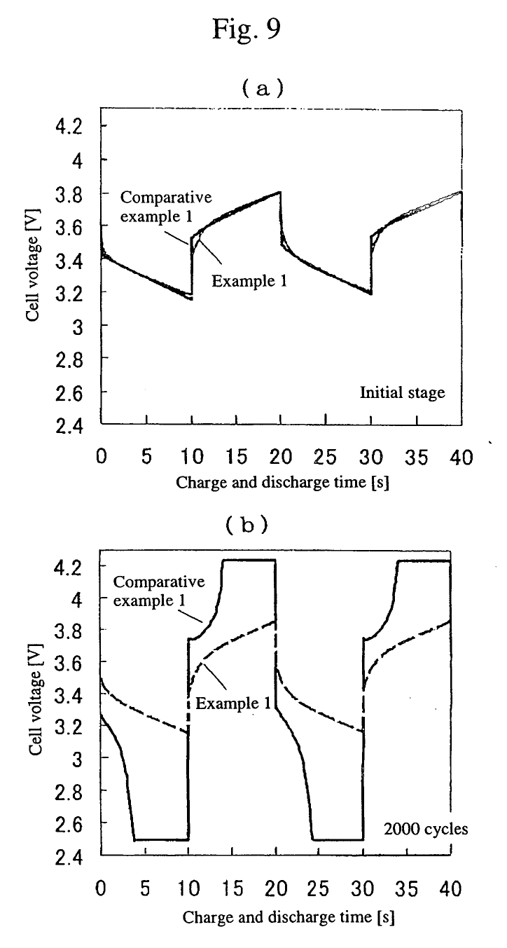

FIGS. 9(A) and 9(B) are line diagrams showing charge and discharge curves in the initial stage during evaluation of the pulse cycle characteristic (A) and in the 2000th cycle (B). In the charge and discharge curve in the initial stage, little difference is found between Example 1 and Comparative Example, but after 2000 cycles, a change in voltage significantly increases compared to the initial stage in Comparative Example 1 while little change is found in Example 1.

From the above description, it was found that use of the energy device of this example can considerably improve the output characteristic and the pulse cycle characteristic at a low temperature. If the positive electrode active material described in Example 1 is used, material costs can be reduced and safety can be improved. If the positive electrode active materials of Examples 5 to 9 are used, the energy density can be improved compared to Example 1, and if the positive electrode active material of Example 6 is used, the energy density can be most improved. For safety, Examples 5, 7, 8 and 9 are superior to Example 6.

### EXAMPLE 10

In the coin-shaped energy storage device of Example 1, an energy storage device in which a mixed electrolytic solution of ethylene carbonate and ethyl methyl carbonate (volume ratio: 1/9) of 1.5 mol/dm³ LiPF₆ and 0.1 mol/dm³ (C₂H₅)₄NBF₄ is injected instead of the mixed electrolytic solution of ethylene carbonate and ethyl methyl carbonate (volume ratio: 1/9) of 1.5 mol/dm³ LiPF₆ is fabricated.

### EXAMPLE 11

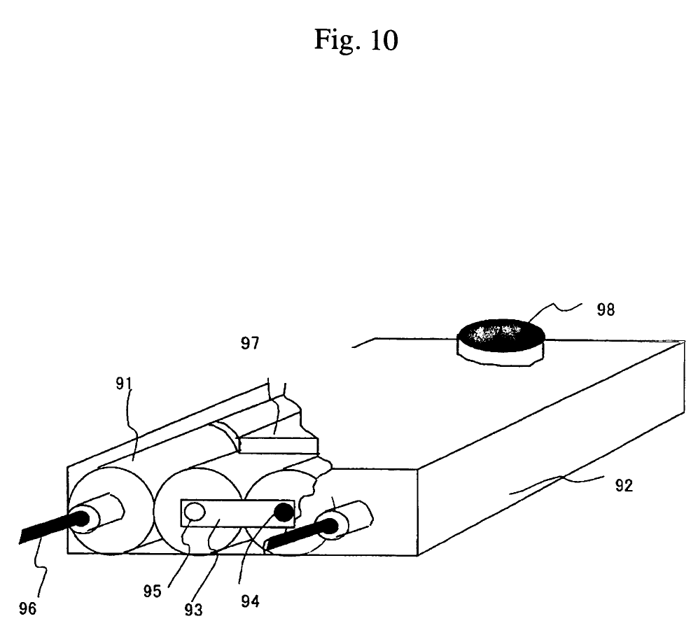

FIG. 10 is a perspective view of an energy storage device module according to the present invention. A plurality of energy storage devices fabricated in Example 1 were used to fabricate an energy storage device module. 24 energy storage devices 91 are connected in series, and housed in rectangular container made of resin 92. For connection between the energy storage devices 91, a copper plate 93 having a thickness of 2 mm was used, and the copper plate 93 was fixedly screwed to connect a positive electrode terminal 94 and a negative electrode terminal 95 of the energy storage device 91. Charge and discharge currents for the module are input/output via a cable 96. Each energy storage device 91 is connected to a control circuit 97 via a signal line, and the voltage and temperature of each energy storage device 91 being charged and discharged can be monitored. The module is provided with a vent hole 98 for cooling.

According to this example, an energy storage device module using energy devices excellent in input/output characteristics at a low temperature is obtained as in examples described previously.

### EXAMPLE 12

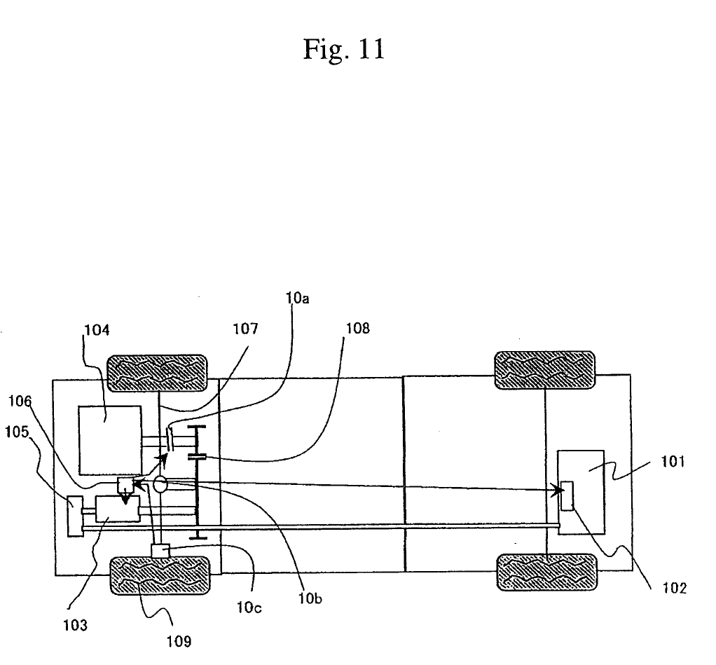

FIG. 11 is an underside plan view of a hybrid type electric vehicle according to the present invention. In this example, two energy storage device modules of Example 11 were used to fabricate a hybrid type electric vehicle. As shown in FIG. 11, they each have an electric vehicle energy storage device module 101, a module control circuit 102, a driving electric motor 103, an engine 104, an inverter 105, a motive power control circuit 106, a driving shaft 107, a differential gear 108, a driving wheel 109, a clutch 10a, a gear 10b and a speed monitor 10c. When the electric vehicle drives off, the power of the energy storage device module 101 is converted into an alternating current power by the inverter 105, and then input to the driving electric motor 103 to drive the driving electric motor 103. The driving wheel 109 can be rotated by the driving electric motor 103 to move the electric vehicle. In accordance with a signal from the motive power control circuit 106, the module control circuit 102 supplies power to the driving electric motor 103 from the energy storage device module 101.

If the speed exceeds 20 km/h during running by the driving electric motor 103, a signal is sent from the motive power control circuit 106, the clutch 10a is connected, and the engine 104 is cranked using rotational energy from the driving wheel 109. The motive power control circuit 106 makes a determination on a signal from the speed monitor 10c and how an accelerator is depressed, and adjusts the supply of power to the driving electric motor 103, whereby the number of rotations of the engine 104 can be adjusted by the driving electric motor 103. During deceleration, the driving electric motor 103 operates as an electricity generator, and power is regenerated in the energy storage device module 101. By mounting the energy storage device module of this example, the input/output characteristics at a low temperature are improved as in the examples described previously, and the energy storage device module can be lightened, resulting in an improvement in fuel efficiency.

In this example, an electric vehicle of a type of hybridization with an internal combustion engine is shown as one example, but hybridization with a fuel cell is also possible, and in this case, parts related to the internal combustion engine such as an engine are absent. Further, a pure electric vehicle having only the energy storage device module as a power supply can be implemented.

### EXAMPLE 13

The energy devices of Examples 1 to 11 and the energy device module of Example 12 can be applied for various kinds of purposes, including power supplies for various types of portable information-communication equipment such as personal computers, word processors, cordless handsets, electronic book players, cellular phones, car phones, pagers, handy terminals, transceivers and portable radios; power supplies for various types of portable equipment such as portable copiers, electronic organizers, electronic calculators, liquid crystal television sets, radios, tape recorders, headphone stereos, portable CD players, video movie players, electric shavers, electronic translators, voice encoders and memory cards; electronic power supplies for household electric appliances such as refrigerators, air conditioners, televisions, stereos, water heaters, electric microwave ovens, dishwashers, dryers, washers, lighting apparatuses and toys; and furthermore, power supplies for industrial equipments such as medical instruments, power storage systems and elevators. According to this example, the energy devices and the energy device module are suitable as power supplies especially for vehicles requiring a high input/output, for example electric vehicles, hybrid electric vehicles and golf carts.

According to this example, an energy storage device module using energy devices excellent in input/output characteristics at a low temperature as in the examples described previously is used, and lightening and an improvement in fuel efficiency can be achieved.

What is claimed is:

1. An energy device comprising:
a positive electrode having a region where a faradic reaction occurs; and
a negative electrode having a region where a faradic reaction occurs,
wherein at least one of said positive and negative electrodes has a region where a faradic reaction having a reaction rate higher than that of said faradic reaction occurs or a region where a non-faradic reaction occurs.

2. The energy device according to claim 1, wherein said region where a faradic reaction having a higher reaction rate occurs or said region where a non-faradic reaction occurs occupies 30 to 100% of an area of a portion exposed on the opposite electrode side.

3. The energy device according to claim 1, wherein said region where a faradic reaction occurs is formed on a current collector in a laminated manner, and said region where a faradic reaction having a reaction rate higher than that of the faradic reaction occurs or said region where a non-faradic reaction occurs is formed on the surface of said region where a faradic reaction occurs in a laminated manner.

4. The energy device according to claim 1, wherein said region where a faradic reaction occurs, and said region where a faradic reaction having a higher reaction rate occurs or said region where a non-faradic reaction occurs are formed in a mixed manner or alternately on the surface of the current collector.

5. The energy storage device according to claim 1, comprising a separator electrically separating said positive and negative electrodes from each other and allowing a mobile ion to pass therethrough, and an electrolytic solution having a nonaqueous solvent comprising said mobile ion.

6. The energy device according to claim 5, wherein said positive and negative electrodes are provided with said region of said positive electrode where a faradic reaction occurs and said region of said negative electrode where a faradic reaction having a higher reaction rate occurs or said region where a non-faradic reaction occurs with the former and latter regions adjacent to each other via said separator, or provided with said region of said positive electrode where a faradic reaction having a higher reaction rate occurs or said region where a non-faradic reaction occurs and said region of said negative electrode where a faradic reaction occurs, said region where a faradic reaction having a higher reaction rate occurs or said region where a non-faradic reaction occurs with the former and latter regions adjacent to each other via said separator.

7. The energy device according to claim 6, wherein said mobile ion has a Li salt or Li compound.

8. The energy device according to claim 1, wherein said positive electrode has said region where a faradic reaction occurs having an active material having a lithium ion, and said region where a faradic reaction having a higher reaction rate or said region where a non-faradic reaction occurs having an active material capable of adsorbing and desorbing said lithium ion.

9. The energy device according to claim 8, wherein said active material having a lithium ion comprises at least one of LiNiₓMn_{y}Co_{z}O₂(x+y+z=1), a composite oxide composed of Li and at least one of transition metals Co, Ni and Mn, and a compound having an olivine structure represented LiMePO₄ (wherein Me is Fe, Co, Cr).

10. The energy device according to claim 9, wherein said composite oxide is composed of at least one of LiCoO₂, LiNiO₂, LiMn₂O₄ and LiNiₓMn_{y}Co_{z}O₂(x+y+z=1).

11. The energy device according to claim 1, wherein said region where a faradic reaction having a higher reaction rate occurs or said region where a non-faradic reaction occurs has a material that stores electricity.

12. The energy device according to claim 11, wherein said material that stores electricity comprises at least one of activated carbonaceous carbon materials and quaternary onium cation salts represented by the formula (1):
[Formula (1)] 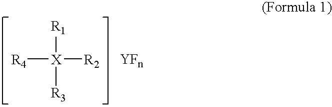
where R1, R2, R3 and R4 each represent H or a C₁₋₃ alkyl group, and they may be same or different; X is N or P; Y is B, P or As; and n is an integer of 4 or 6.

13. The energy device according to claim 1, wherein the energy device has an electrolytic solution or a gel electrolyte composed of a polymer and an electrolytic solution between said positive electrode and negative electrode.

14. A secondary battery which is a coin-shaped or cylindrical battery comprising the energy device according to claim 1 and having shape.

15. A redox capacitor comprising the energy device according to claim 1.

16. An energy device module comprising a plurality of the energy storage devices according to claim 1 connected to each other in series, in parallel, or in series-parallel, and a control circuit for controlling at least any one of the current and the voltage of an electric circuit formed by said connection.

17. An electric vehicle comprising the energy storage device module according to claim 16 mounted therein and an electric motor driven by the power supplied by said module.

18. A hybrid vehicle comprising the energy storage device module according to claim 16 mounted therein, and an electric motor driven by the power supplied by said module and an internal combustion engine.
